(19) United States
(12) Patent Application Publication
(10) Pub. No.: US 2005/0159988 A1
(43) Pub. Date: Jul. 21, 2005

(54) Automated vehicle check-in system

(76) Inventor: Robert C. Ramseyer, Farmington, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/077,437

(22) Filed: Mar. 10, 2005

Related U.S. Application Data
(63) Continuation of application No. 10/980,259, filed on Nov. 3, 2004.
(60) Provisional application No. 60/516,931, filed on Nov. 3, 2003.

(51) Int. Cl. G06F 17/60

(52) U.S. Cl. 705/5; 235/375; 340/425.5; 705/30

(57) ABSTRACT

A fully automated rental vehicle check-in system includes a sending module connected to the diagnostic port of the vehicle. The sending module gathers information from the vehicle including the vehicle identification number, mileage and fuel level and delivers the information wirelessly to a receiving station located in the rental return lot. The information is delivered to a CPU which uses the information along with the time, date and location of the rental lot to compute the rental charges which are delivered to a return kiosk where the charges are paid and a receipt delivered to the customer.

### RELATED APPLICATIONS

This application is a continuation-in-part of U.S. patent application Ser. No. 10/980,259 filed Nov. 3, 2004, which claims priority of U.S. Provisional Patent Application Ser. No. 60/516,931 filed Nov. 3, 2003.

### FIELD OF THE INVENTION

This invention relates to an automated check-in system for vehicles and more particularly to an automated system having an information module connected to the electronic control units of the vehicle.

### BACKGROUND OF THE INVENTION

When a vehicle is taken to a service facility or rental site, it must be checked in. In rental operations, an attendant gathers rental information such as contract number from the contract, vehicle identification number from a tag on the vehicle, mileage from the odometer, and a fuel tank reading from a gauge. The attendant manually enters this information into a handheld device. The information is relayed from the handheld device by radio frequency to a remote central database which then computes the charges for the vehicle rental. The customer then proceeds to the rental office where a counter person collects the fees for the rental. In some cases, rental car companies have preexisting payment arrangements with the customer so that the rental charges are relayed back to the attendant's handheld device and a receipt is provided to the customer by the attendant. However, such systems require the attendant to enter the rental information into the handheld device. Entry into the handheld device is done by keyboard, and in many cases errors are made during the entry of the information.

When a vehicle is serviced at a dealership or maintenance facility it is necessary to manually enter a vehicle identification number and to obtain the mileage. Accordingly, it would be advantageous to provide a device which would reduce the labor needed for vehicle check-in as well as improving the accuracy of the data provided.

### SUMMARY OF THE INVENTION

It is therefore an object of the invention to provide an automated system for checking in vehicles to a rental lot or service facility. A final embodiment of the invention includes an information module which is mounted to the vehicle. The information module has an information gathering device for gathering electronic information from the vehicle data bus. The information includes vehicle identification number, mileage and fuel level. The information module may be connected to the diagnostic port of the vehicle. A processor and information interface in the module obtain the needed information from the vehicle and deliver it by wireless device to a receiving station. Once the vehicle is on the premises of the lot, the activation device initiates the sending module to transmit the information. The information module sends information to the receiving station which delivers the information to a CPU which has a database containing files which obtain rental information and pricing information. The CPU calculates the charges for the rental vehicle based on information gathered from the information unit and produces a rental charge. A receipt may be provided to the customer at a kiosk located at the rental lot.

A second embodiment of the invention includes a handheld module having a plug and a keyboard. This embodiment is particularly adapted for use in service facilities.

### BRIEF DESCRIPTION OF THE DRAWING

A better understanding of the present invention will now be had in reference to the accompanying drawing wherein like reference characters refer to like parts throughout the several views herein in which:

FIG. 1 is a schematic diagram showing a check-in system in accordance with the preferred embodiment of the invention;

FIG. 2 is a schematic view of a sending module connected to a vehicle in accordance with the preferred embodiment of the invention;

FIG. 3 is a block diagram showing the method in accordance with the preferred embodiment of the invention;

FIG. 4 is a schematic view of a first alternative preferred embodiment of a check in system in accordance with the invention; and

FIG. 5 is a schematic view of a second alternative preferred embodiment of a wireless check in system in accordance with the invention.

### DETAILED DESCRIPTION OF THE INVENTION

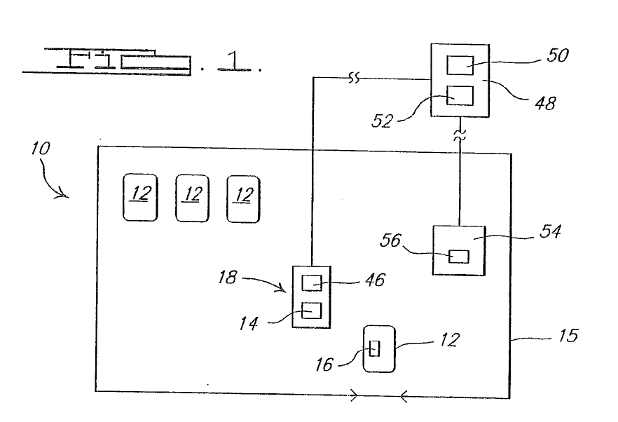

A preferred embodiment of a fully automated check-in system 10 for a vehicle 12 is shown in FIG. 1. The system is particularly useful in rental operations. The system includes an activation device 14 positioned in or about a rental lot 15. The activation device 14 initiates an information module 16 which is mounted to the vehicle 12. The sending module transmits information to a receiving device 18 which is connected to a CPU 48 for checking in the vehicle 12.

The activation device 14 may be of any type device which activates the module when the vehicle enters the return lot 16 of the rental car operation. The activation device may be a two-way radio and incorporated into the receiving station 18. However, other types of devices such as magnetic strips which interact with a magnetic switch in the information module 16 may be used. Alternatively the activation device can be mounted directly in the vehicle in the form of a GPS unit which is programmed to activate the information module 16 when the vehicle 12 enters into the return lot 15. The locations of the return lots are programmed into the GPS unit as waypoints. When the GPS unit recognizes one of the waypoints, a signal is sent to activate the information unit.

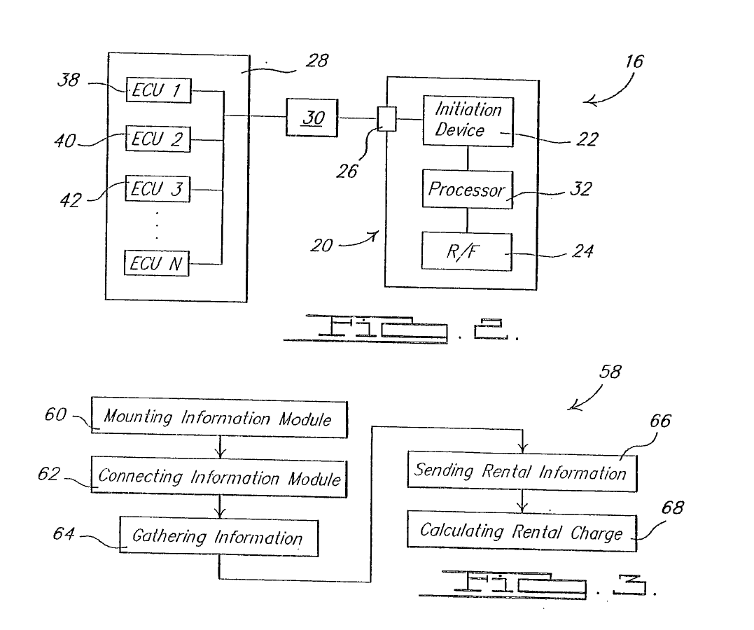

As best shown in FIG. 2, the information module 16 is a compact device which is fixedly mounted to the vehicle. The information module 16 has a housing 20 which holds an initiation device 22, an information gathering device or processor 32, and a wireless transmission device 24. The module 16 has a connector 26 for connection to a conventional data bus 28 which is provided in vehicles. The bus 28 carries electronic information signals from the sensors and electrical components of the vehicle 12. In the preferred embodiment, the information module 16 is connected directly to electronic control units of the vehicle 12. The diagnostic port 30 is a federally mandated port which permits access to the information contained within the vehicle 12.

The information gathering device 22 includes a processor 32 and interface 34 which directs the processor 32 to gather rental information from the data bus 28. This information includes vehicle identification number 38, fuel level 40, and vehicle mileage 42. If desired, diagnostic information 44 can be obtained for updating service records and vehicle maintenance at the same time. The processor then activates the transmission device 24 to transmit the rental information 36 obtained wirelessly by using a Bluetooth or 802.11 protocol to the receiving station 18.

The receiving station 18 has a radio receiver 46 which receives the information from the information unit. The receiving station is located in the rental lot 16. The receiver 16 is connected to a CPU 48. The CPU may be located at the rental lot or a remote location and includes a database 50 with files 52 having rental information for the vehicle 12. When the CPU 48 receives return information from the receiver, the location of the rental lot and a timestamp are entered into the file. The CPU then utilizes the rental information from the vehicle to calculate the charges for the rental. Any maintenance problem such as oil life, low tire pressure, or potential maintenance problems as identified by the diagnostic trouble codes are relayed to the vehicle maintenance department for attention by the maintenance staff.

The charges for the rental are then delivered to a kiosk 54 located in the rental lot 16 where the customer is prompted to pay the charges which are displayed on a screen. The customer may use a credit card, debit card or the like to pay the charge. In many instances, the customer may have a previous agreement or account with the rental company such that it is not necessary to pay the charges at the time. A receipt from the printer of the kiosk by an attendant with a mobile printer is then delivered to the customer or may be separately mailed or emailed to the customer.

As shown in FIG. 3, the method 58 in accordance with the invention includes the steps of mounting 60 an information module in a vehicle, connecting 62 the module to the data bus of the vehicle gathering 64 rental information from the data bus, sending rental information taken from the data bus to a remote station and calculating 68 the rental charge for the vehicle using the rental information sent from the information module. Additionally, the system includes charging the customer for the rental and providing a receipt.

Thus is provided a fully automated and inexpensive information retrieval and delivery system for rental vehicles. The system permits the elimination of check-in attendants and ensures the accuracy of the delivery of information. The speed of rental check-in is increased and vehicle maintenance problems are reduced by obtaining accurate information on such things as oil level, tire pressure and contained in diagnostic trouble codes.

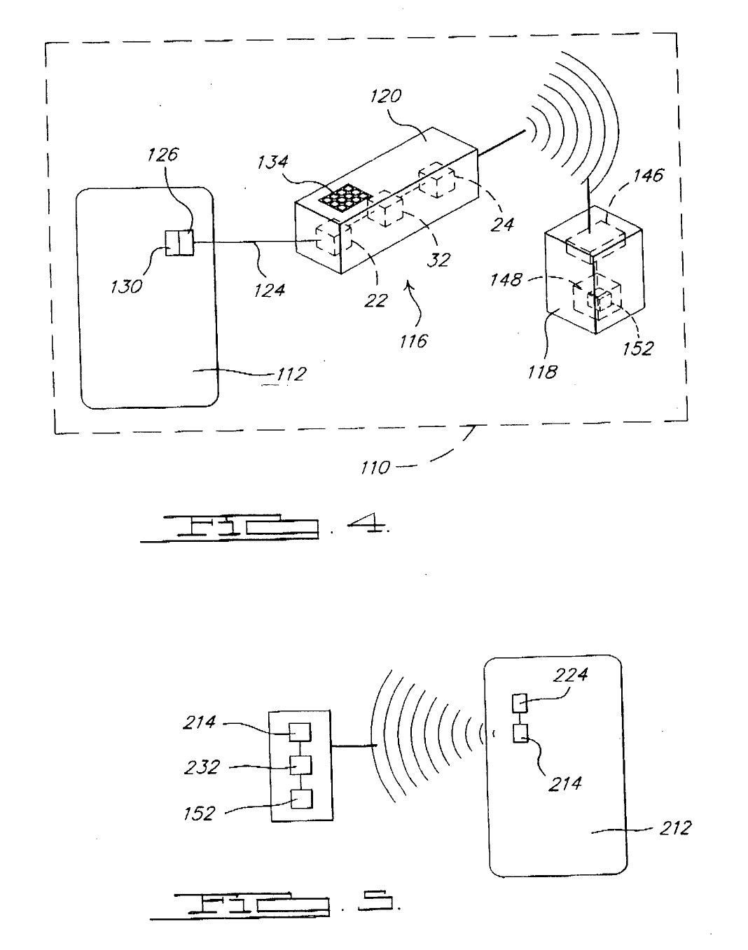

As shown in FIG. 4, an alternative embodiment of the invention is an automated check-in system 110 for a vehicle 112 at a service facility such as a dealership or repair shop. The system includes a handheld information module 116 which has a wire lead 124 with a connector 126 adapted for connection to the diagnostic port 30 of a vehicle 112. The information module 116 has a housing 120 which holds information gathering device or processor 32, and wireless transmission device 24 in similar fashion as described for the previous embodiment. As above, the processor gathers necessary information for the vehicle check-in including the vehicle identification number, mileage and diagnostic data from the port. This information is relayed by the wireless transmission device 24 to a receiving station 118. The receiving station has a receiver 146 and a CPU 148 which places the information in a file 152 for the vehicle from which the work order to process the vehicle can be produced. The information module may also be provided with a keyboard 134 for entry of other information such as type of service which is requested by the customer and in the case of older vehicles information which is not provided automatically through the data bus.

As shown in FIG. 5, if the vehicle is equipped with an RF module such as a Bluetooth module, the check-in system for a service facility or rental site may be adapted to operate as shown in FIG. 6. An activation device 214 located remotely from the vehicle 212 will query a data gathering processor in the vehicle 214 through a wireless module 224. A receiving processor 232 will gather the appropriate check-in information and deliver the information to the processor 148 and place the information in the file 152 as above.

While the present invention has been described in its preferred forms with a certain degree of particularity, it is understood that the present disclosure of the several preferred embodiments has been by way of example and that numerous changes to the detailed construction, combination and arrangement of the elements may be resorted to without departing from the spirit and scope of the invention as hereinafter claimed.

1. A system for checking in a vehicle having a data bus into a facility, said device comprising:
a module, said module having an information gathering device for gathering check in information from said vehicle, said module connected to said data bus of said vehicle;
a wireless transmission device for transmitting said information;
a remote receiving station, said station receiving said check in information from said sending module; and
a CPU connected to a database with a file for said vehicle, said CPU placing said check in information in said file to check in said vehicle.

2. The device of claim 1 wherein said check in information comprises a vehicle identification number, a mileage, and a diagnostic code.

3. The device of claim 1 wherein said vehicle has a data bus and wherein said sending module is connected to the data bus.

4. The device of claim 3, wherein said vehicle has a port connected to said data bus and said sending module is connected to said port.

5. The device of claim 1 wherein said CPU computes a rental charge for said vehicle.

6. The device of claim 5 further comprising a receipt station wherein a receipt for said rental charge is produced.

7. A method of checking in a rental vehicle at a return lot, said method comprising the steps of:
mounting a sending module to a data bus of said vehicle module;
gathering rental information from a data bus
sending the check in information to a remote station; and
calculating a rental charge for said vehicle using the check in information sent from said sending module.

8. The method of claim 7 further comprising the step of providing a receipt for the rental charges.

9. The method of claim 7 wherein said mounting step further comprises the step of connecting the sending module to a diagnostic port of said vehicle.

10. The method of claim 7 wherein said rental information includes vehicle information number, mileage, and fuel level.
